(19) United States
(12) Patent Application Publication
(10) Pub. No.: US 2011/0000223 A1
(43) Pub. Date: Jan. 6, 2011

(54) GAS TURBINE COMPONENT AND A METHOD FOR PRODUCING A GAS TURBINE COMPONENT

(75) Inventor: David Russberg, Trollhattan (SE)

Correspondence Address: WRB-IP LLP, 801 N. Pitt Street, Suite 123, ALEXANDRIA, VA, 22314, US

(73) Assignee: Volvo Aero Corporation, Trollhattan (SE)

(21) Appl. No.: 12/919,221

(22) PCT Filed: Feb. 25, 2008
(86) PCT No.: PCT/SE2008/000154

§ 371 Date: Sep. 1, 2010

(51) Int. Cl. F02C 7/20; B23P 15/04

(52) U.S. Cl. 60/796; 29/889.2

(57) ABSTRACT

A gas turbine component includes an inner ring, an outer ring, and a plurality of circumferentially spaced struts which are rigidly connected to the inner ring and the outer ring forming a load-carrying structure. The component includes at least one fairing connected to two adjacent struts defining a gas channel between the struts and the fairing.

### BACKGROUND AND SUMMARY

The present invention relates to a gas turbine component comprising a load-carrying structure, wherein the structure comprises a plurality of circumferentially spaced struts. The invention is further directed to a gas turbine engine, and especially to an aircraft engine, comprising the component. Thus, the invention is especially directed to a jet engine. The invention is further directed to a method for producing a gas turbine component.

Jet engine is meant to include various types of engines, which admit air at relatively low velocity, heat it by combustion and shoot it out at a much higher velocity. Accommodated within the term jet engine are, for example, turbojet engines, turbofan and turboprop engines. The invention will below be described for a turbofan engine, but may of course also be used for other engine types.

An aircraft gas turbine engine of the turbofan type with two shafts generally comprises a forward fan and booster compressor, a middle core engine, and an aft low pressure power turbine. The core engine comprises a high pressure compressor, a combustor and a high pressure turbine in a serial relationship. The high pressure compressor and high pressure turbine of the core engine are interconnected by a high pressure shaft. The high-pressure compressor is rotatably driven to compress air entering the core engine to a relatively high pressure.

This high pressure air is then mixed with fuel in the combustor and ignited to form a high energy gas stream. The gas stream flows aft and passes through the high-pressure turbine, rotatably driving it and the high pressure shaft which, in turn, rotatably drives the high pressure compressor.

The gas stream leaving the high pressure turbine is expanded through a second or low pressure turbine. The low pressure turbine rotatably drives the fan and booster compressor via a low pressure shaft. The low pressure shaft extends through the high pressure rotor. Most of the thrust produced is generated by the fan. Engine frames are used to support and carry the bearings, which in turn, rotatably support the rotors. Conventional turbo fan engines have a fan frame, an intermediate frame and an aft turbine frame.

The invention is of course not limited to application in a two-shaft engine, but may very well be applied in other engine types, such as a three shaft engine.

The term strut refers to a structural vane, i.e. a vane carrying a load in operation. Struts are often hollow in order to house service components such as means for the intake and outtake of oil and/or air, for housing instruments, such as electrical and metallic cables for transfer of information concerning measured pressure and/or temperature etc. The struts normally have a symmetric airfoil shape in cross section in order to effect the gas flow as little as possible. The servicing requirement usually governs the number of struts required.

An intermediate compressor component (also called structure or frame) is positioned between two compressor stages (for example the low pressure compressor and the high pressure compressor). The intermediate compressor structure is adapted to transfer loads and form support for bearings.

According to a known production technique, the intermediate compressor component is casted in one single piece. Casting large components with high demand on accuracy is expensive. Thus, there is a demand for alternative production techniques. It is further known to first cast component parts individually and then welding the casted component parts together. However, the welding implies some limitations in the production and in the shape of the component parts due to the fact that the welds have to be performed in a specific sequence. Further, the welding positions are in some applications difficult to access, which leads to long manufacturing time and/or to a costly production.

It is desirable to achieve a gas turbine component, and especially an intermediate compressor structure or frame, which is more cost-efficient in production while maintaining or improving its operational characteristics.

According to an aspect of the present invention, a component comprises at least one fairing connected to two adjacent struts defining a gas channel between the struts and the fairing. Preferably, the component comprises at least one pair of fairings arranged at a distance from each other in a radial direction of the component, wherein the fairings are connected to two adjacent struts defining a gas channel between the struts and the fairings.

This solution creates conditions for a facilitated production in that the gas channel walls (the fairings) may be introduced in the component at a later stage during assembly. For example, in production, the struts may be welded individually and then connected to inner and outer rings via welding. The fairings are connected to the struts subsequently. Thus, there will be a significantly improved access to the welding regions internally of the inner and outer ring.

Further, in the prior art components, the gas channel walls were an integral part of the casting. Thus, the prior art gas channel walls were load-carrying. The invention creates conditions for using fairings which are substantially non-load-carrying. In other words, the fairings solely form gas flow guiding means. Thus, the fairings can be made of thinner material, such as sheet metal, wherein the final component will be lighter than prior art components.

According to a preferred embodiment, said at least one fairing is connected to at least one of said struts via at least one connection device.

By introducing a connection device for at least one of the connections between the struts and the fairing, there will be more flexibility in the production. More specifically, some welds may be avoided (especially the prior art welds for connecting the gas channel walls to the struts) and the order in which the different welds are performed may be altered. This, may in turn lead to improved tolerances. Especially, the strut may be joined to the fairing at a later point in time in the production process than was possible according to the previously known technique.

According to a further preferred embodiment, the connection device comprises a connection element.

According to a preferred example, the connection element is formed by a bolt. Alternatively, the connection element may be formed by a rivet.

According to a further preferred embodiment, the connection device comprises at least one bracket positioned between the strut and the fairing and that the connection element is adapted to clamp the bracket to one of the strut and the fairing. This leads to a secure and reliable connection between the strut and the fairing.

It is desirable to achieve a method for producing a gas turbine component, especially an intermediate compressor structure or frame, which is cost-efficient while maintaining or improving the component's operational characteristics.

A method according to another aspect of the present invention comprises the steps of

providing a load-carrying structure comprising a plurality of circumferentially spaced struts, and

connecting at least one fairing to at least two of said struts so that the fairing define a gas channel between the struts and the fairing.

This solution creates conditions for a facilitated production in that the gas channel walls (the fairings) may be introduced in the component at a later stage during assembly. For example, in production, the struts may be welded individually and then connected to inner and outer rings via welding. The fairings are connected to the struts subsequently. Thus, there will be a significantly improved access to the welding regions internally of the inner and outer ring.

According to a further preferred embodiment, the method comprises the step of connecting at least one of said fairings to at least one of said struts via at least one connection device.

By introducing a connection device for at least one of the connections between the struts and the fairings, there will be more flexibility in the production. More specifically, some may be avoided (especially the prior art welds for connecting the gas channel walls to the struts) and the order in which the different welds are performed may be altered. This, may in turn lead to improved tolerances. Especially, the strut may be joined to the fairing at a later point in time in the production process than was possible according to the previously known technique.

Other advantageous features and functions of various embodiments of the invention are set forth in the following description and in the dependent claims.

### BRIEF DESCRIPTION OF THE DRAWINGS

The invention will be explained below, with reference to the embodiment shown on the appended drawings, wherein

FIG. 1 is a schematic side view of the engine cut along a plane in parallel with the rotational axis of the engine,

FIG. 2 is a schematic, perspective view of an intermediate component from FIG. 1,

FIG. 3 is a perspective view from a first direction of a strut-fairing connection in the component in FIG. 2, and

FIG. 4 is a perspective view from a second direction of the strut-fairing connection in FIG. 3.

### DETAILED DESCRIPTION

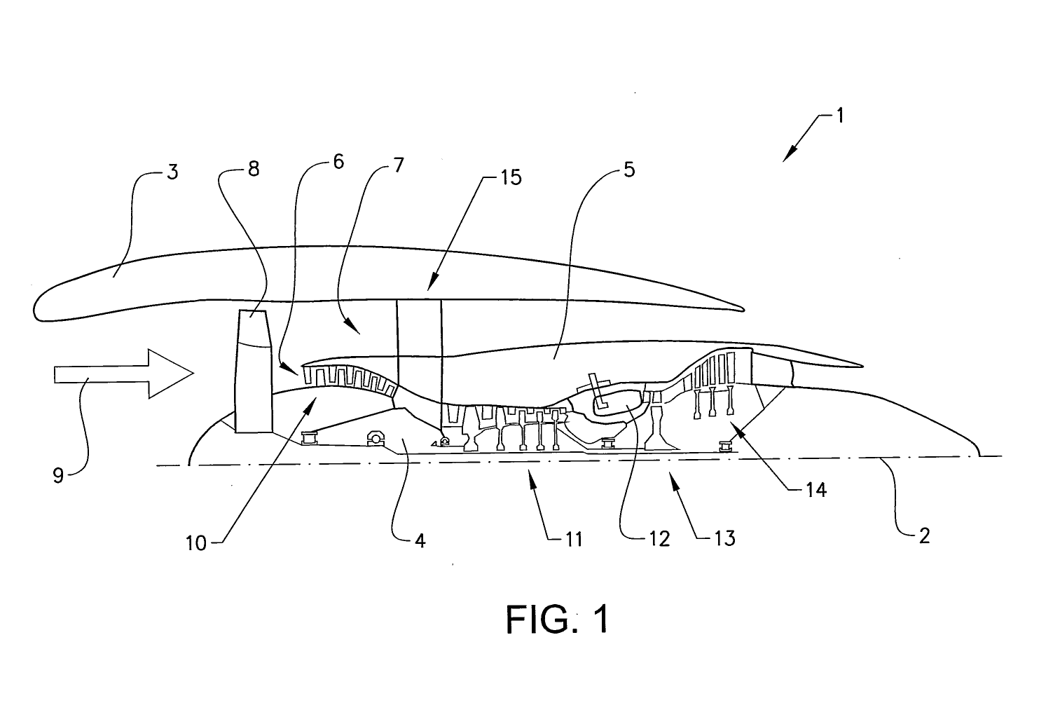

The invention will below be described for a two-shaft turbofan gas turbine aircraft engine 1, which in FIG. 1 is circumscribed about an engine longitudinal central axis 2. The engine 1 comprises an outer casing or nacelle 3, an inner casing 4 (rotor) and an intermediate casing 5 which is concentric to the first two casings and divides the gap between them into an inner primary gas channel 6 for the compression of air and a secondary channel 7 in which the engine bypass air flows. Thus, each of the gas channels 6,7 is annular in a cross section perpendicular to the engine longitudinal central axis 2.

The engine 1 comprises a fan 8 which receives ambient air 9, a booster or low pressure compressor (LPC) 10 and a high pressure compressor (HPC) 11 arranged in the primary gas channel 6, a combustor 12 which mixes fuel with the air pressurized by the high pressure compressor 11 for generating combustion gases which flow downstream through a high pressure turbine (HPT) 13 and a low pressure turbine (LPT) 14 from which the combustion gases are discharged from the engine.

A high pressure shaft joins the high pressure turbine 13 to the high pressure compressor 11 to substantially form a high pressure rotor. A low pressure shaft joins the low pressure turbine 14 to the low pressure compressor 10 to substantially form a low pressure rotor. The low pressure shaft is at least in part rotatably disposed co-axially with and radially inwardly of the high pressure rotor.

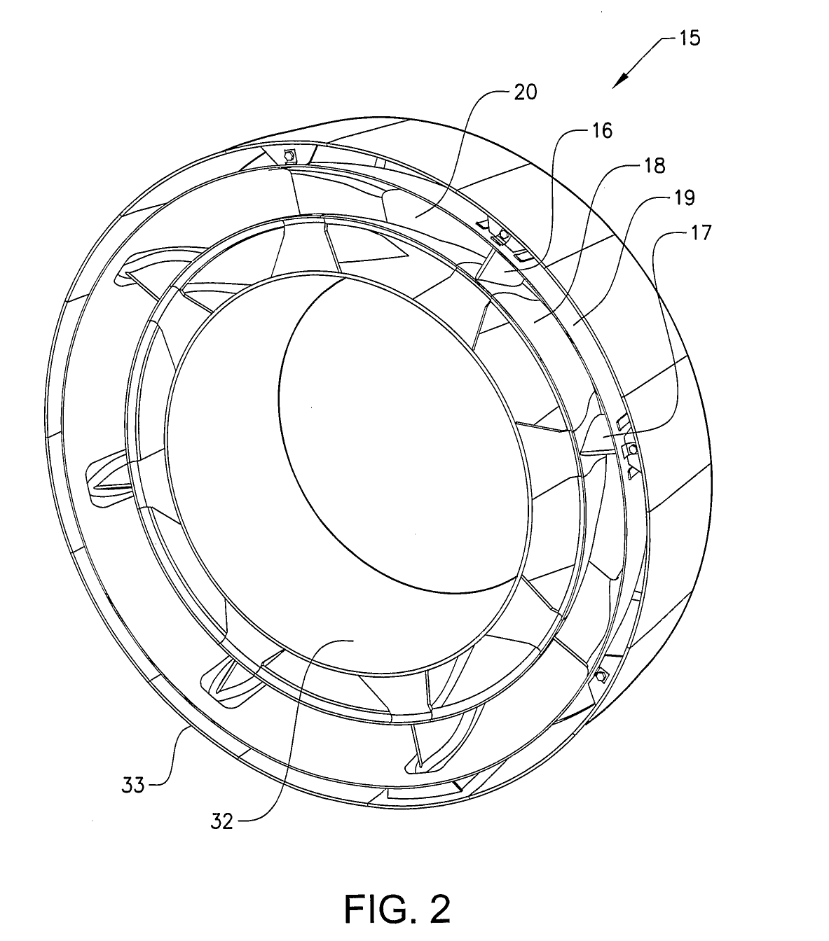

The casings 3, 4, 5 are supported by a component, or structure, 15, see FIG. 2, which connect the housings by a plurality of circumferentially spaced radial arms 16, 17. These arms are generally known as struts. Further, the struts are designed for transmission of loads in the engine. Further, the struts are hollow in order to house service components such as means for the intake and outtake of oil and/or air, for housing instruments, such as electrical and metallic cables for transfer of information concerning measured pressure and/or temperature, a drive shaft for a start engine etc. The struts can also be used to conduct a coolant.

The compressor component 15 connecting the intermediate casing 4 and the inner casing 3 can for example be applied as an Intermediate Case (IMC), Intermediate Compressor Case (ICC) or Fan Hub Frame (FHF). The component 15 is designed for guiding the gas flow from the low pressure compressor section 10 radially inwards toward the high pressure compressor section inlet.

The component 15 comprises an inner ring 32, an outer ring 33 and said plurality of circumferentially spaced struts 16, 17 which are rigidly connected to the inner ring 32 and the outer ring 33 forming a load-carrying structure.

Further, the component comprises at least one fairing 18, 19 connected to two adjacent struts defining a gas channel 20 between the struts and the fairing. The fairing forms a curved flow guiding surface and extends in a circumferential direction of the component. More specifically, the fairing 18, 19 forms an annular element, which is non-load-carrying. Thus, the fairing solely has a flow-guiding function.

More specifically, a pair of fairings 18, 19 are arranged at a distance from each other in a radial direction of the component. The fairings 18, 19 are connected to two adjacent struts defining a gas channel 20 between the struts and the fairings. Each of the fairings is connected to at least three struts 16, 17 defining a plurality of circumferentially spaced gas channels 20 between the struts and the fairings. In the shown example, the fairings 18, 19 form circumferentially closed annular elements. Each of the fairings is preferably connected to all struts 16, 17 in the component.

Thus, a plurality of circumferentially spaced gas channels 20 are formed in the component 15, which gas channels together form a part of the inner primary gas channel 6, see FIG. 1.

The struts 16, 17 are structural parts, designed for transmission of both axial and radial loads and are hollow in order to house service components.

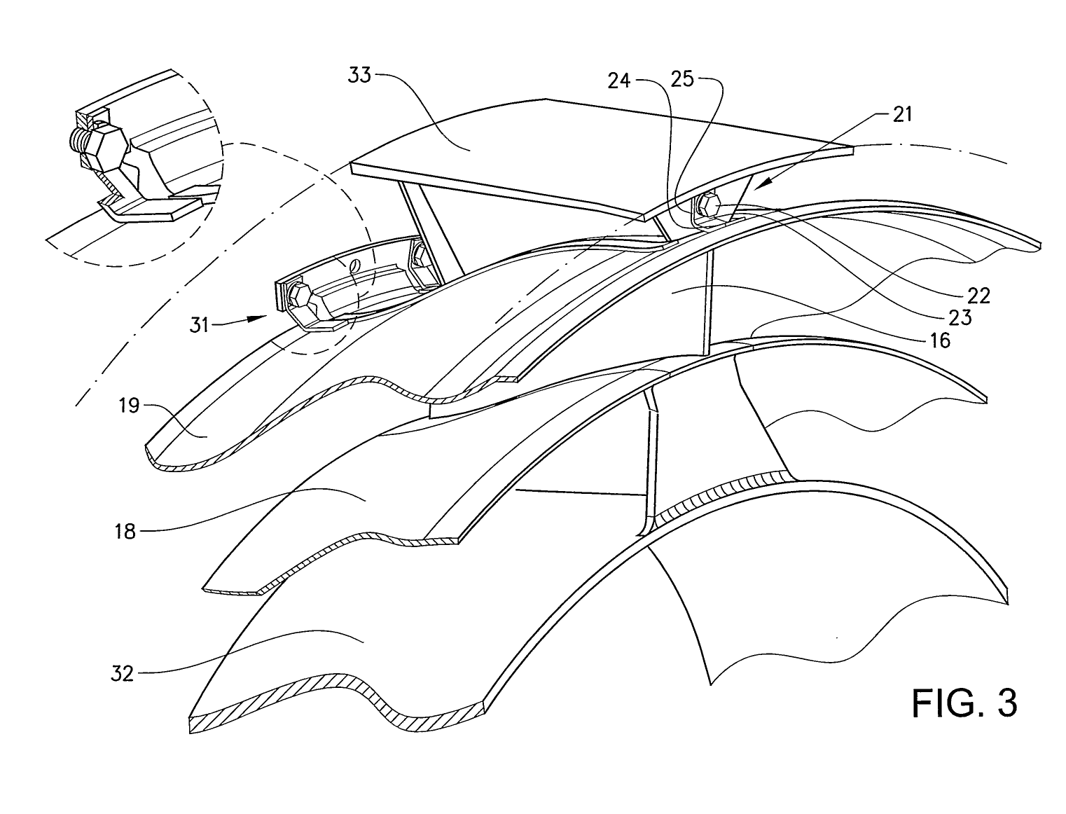

FIG. 3 shows a schematic, perspective view of the strut 16 arranged between the fairings 18, 19 in the component in FIG. 2.

The radially outer fairing 19 is connected to the strut 16 via a first, upstream connection device 21 and a second, downstream connection device 31. The strut 16 extends past the fairings 18, 19 in the radial direction. The strut 16 is joined to each of the fairings 18, 19 on an opposite side of the gas channel 20. Thus, the connection devices 21, 31 are positioned on an exterior side of the gas channel.

The first, upstream connection device 21 comprises a bracket 23 positioned between the strut 16 and the fairing 19 and a connection element 22 in the form of a bolt. The bracket 23 comprises a first portion 24, which is joined to the fairing 19 and a second portion 25, which is joined to the strut. The first portion 24 is joined to the fairing 19 via a spot weld or similar. Alternatively, the bracket 24 may be formed as an integral part of the fairing 19. The second portion 25 comprises a hole for receipt of the bolt 22. The bolted connection is adapted to clamp the bracket 23 to the strut 16. The first portion 24 of the bracket 23 is inclined in relation to the second portion 25 of the bracket.

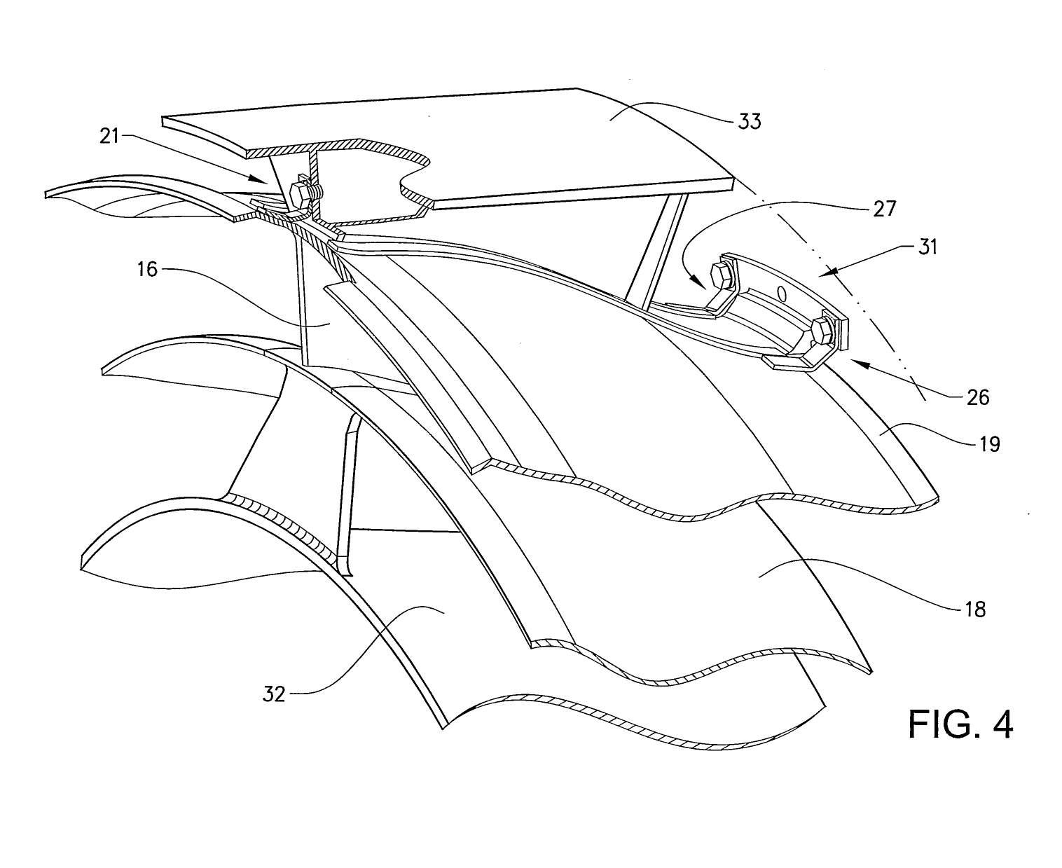

The second, downstream connection device 31 is shown in more detail in FIG. 4. The device 31 comprises two circumferentially spaced brackets 26, 27. The brackets 26, 27 are identical. Further, the brackets 26, 27 are identical with the bracket 23 in the first, upstream connection device 21. The term “identical” means that they have the same shape, dimension and are made of the same material. The brackets 26, 27 are connected to the strut and the fairing, respectively, in a similar manner as has been described above for the upstream bracket 23. The connection of the strut 16 to the inner fairing-18 may be solved according to a similar principle as described above for the outer fairing 19.

The invention is not in any way limited to the above described embodiments, instead a number of alternatives and modifications are possible without departing from the scope of the following claims.

For example, the intermediate compressor structure described above is adapted to transfer loads and form support for bearings. However, the invention may also be applicable in other components of the gas turbine engine, such as in components, which form housings or casings, i.e. components which are not specifically designed for load transfer and bearing support.

Further, the design of the fairing 18, 19 is not limited to form a closed circle. Instead, an annular structure, preferably a circumferentially closed structure, may be formed by a plurality of interconnected fairings. Further, the term “fairing” should be construed as a flow guiding wall and is not limited to a single wall, or sheet. For example, a fairing may be formed by a double wall with or without any intermediate means.

Further, the connection elements 22 (bolts) are applied in a generally axial direction in the example described above. Thus, the bolts have a generally axial extension in the attached state. However, the connection elements may be applied in any other direction. According to an alternative, the connection elements are applied in a circumferential direction of the component.

Further, the connection element in the form of a bolt described above, may be replaced by a rivet.

Further, of course the downstream brackets 26, 27 does not have to be identical. They may be different in shape, dimension and material relative to each other. Further, none of the brackets 26, 27 needs to be identical with the upstream bracket 21. They may be different in shape, dimension and material relative to the upstream bracket 21.

Further, according to an alternative to using a pair of fairings as flow-guiding surfaces in the component, only one fairing is connected to the load-carrying structure, wherein the other flow-guiding surface in the component is integrated in the load-carrying structure.

1. A gas turbine component (15) comprising a load-carrying structure, wherein the structure comprises a plurality of circumferentially spaced struts (16,17), characterized in that the component comprises at least one fairing (18,19) connected to two adjacent struts (16,17) defining a gas channel (20) between the struts and the fairing.

2. A gas turbine component according to claim 1, characterized in that said at least one fairing (19) is connected to at least one of said struts (16) via at least one connection device (21,31).

3. A gas turbine component according to claim 2, characterized in that the connection device (21,31) is positioned on an exterior side of the gas channel.

4. A gas turbine component according to claim 2 or 3, characterized in that the connection device (21,31) comprises a connection element (22).

5. A gas turbine component according to claim 4, characterized in that the connection element is formed by a bolt (22).

6. A gas turbine component according to claim 4, characterized in that the connection element is formed by a rivet.

7. A gas turbine component according to any one of claims 2-6, characterized in that the connection device comprises at least one bracket (23,26,27) positioned between the strut (16) and the fairing (19) and that the connection element is adapted to clamp the bracket to one of the strut and the fairing.

8. A gas turbine component according to claim 7, characterized in that the bracket (23) comprises a first portion (24), which is joined to the fairing and a second portion (25), which is joined to the strut.

9. A gas turbine component according to claim 8, characterized in that the first portion (24) of the bracket is inclined in relation to the second portion (25) of the bracket.

10. A gas turbine component according to any one of claims 4-6 and any one of claims 7-9, characterized in that the bracket is joined to the strut via the connection element (22).

11. A gas turbine component according to any one of the previous claims characterized in that the fairing (18,19) forms an annular element and that the fairing is connected to at least three struts (16,17) defining a plurality of circumferentially spaced gas channels (20) between the struts and the fairing.

12. A gas turbine component according to any one of the previous claims characterized in that the fairing (18,19) forms a circumferentially closed annular element.

13. A gas turbine component according to any one of the previous claims characterized in that the fairing (18,19) forms a non-load carrying gas channel wall.

14. A gas turbine component according to any one of the previous claims characterized in that the structure comprises at least one pair of fairings (18,19) arranged at a distance from each other in a radial direction of the component, wherein the fairings (18,19) are connected to two adjacent struts (16,17) defining a gas channel (20) between the struts and the fairings.

15. A gas turbine component according to any one of the previous claims characterized in that the structure comprises an inner ring (32) and an outer ring (33) and that the struts are rigidly connected to the inner ring (32) and to the outer ring (33).

16. A gas turbine component according to any one of the previous claims characterized in that the component is adapted for being used as an intermediate frame (15) in a gas turbine engine.

17. A gas turbine engine (1) characterized in that it comprises a gas turbine component according to any one of the previous claims.

18. A gas turbine engine (1) according to claim 17, characterized in that the gas turbine component is positioned between two compressor stages (10,11).

19. A method for producing a gas turbine component, comprising the steps of
providing a load-carrying structure comprising a plurality of circumferentially spaced struts (16,17), and
connecting at least one fairing (18,19) to at least two of said struts so that the fairing define a gas channel (20) between the struts and the fairing.

20. A method according to claim 19, comprising the step of connecting at least one pair of fairings (18,19) to at least two of said struts so that the fairings are arranged at a distance from each other in a radial direction of the component and define a gas channel (20) between the struts and the fairings.

21. A method according to claim 19 or 20, comprising the step of providing a load-carrying structure comprising an inner ring (32), an outer ring (33) and that the struts are rigidly connected to the inner ring (32) and the outer ring (33).

22. A method according to any of the claims 19-21, comprising the step of connecting said at least one fairing (19) to at least one of said struts (16) via at least one connection device (21,31).

23. A method according to any of the claims 19-22, wherein the fairing (18,19) forms circumferentially closed annular elements.
